(19) United States
(12) Patent Application Publication
(10) Pub. No.: US 2005/0220132 A1
(43) Pub. Date: Oct. 6, 2005

(54) Multicast

(75) Inventors: Andreas Oman, Bagarmossen (SE); Fredrik Nyman, Sollentuna (SE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: PacketFront Sweden AB

(21) Appl. No.: 10/859,457

(22) Filed: Jun. 2, 2004

(30) Foreign Application Priority Data
Mar. 30, 2004 (SE) 0400825-6

(51) Int. Cl. H04L 12/28

(52) U.S. Cl. 370/432; 370/390

(57) ABSTRACT

A method and a system in a data packet network (10) is provided for controlling access to media channels (16), to for instance a television user through multicasting. It provides to a host (STB) for a user requested denied multicast stream (16) services and information through an alternate channel (17).

### BACKGROUND OF THE INVENTION

1. Technical Field

The present invention pertains to a method and a system in a data packet network controlling access to multicast channels, providing to a host for a user requested alternated multicast groups/streams with services and information.

2. Description of Related Art

In computer networks, utilizing the Internet Protocol (IP), a technology known as multicast is utilized. Multicast is the transmission of data packets from one or multiple sources to a plurality of receivers. It is possible to multicast “multiple-to-multiple”, the most frequent use of multicast today is for “one-to-multiple”. It can be utilized to efficiently transmit a data stream from a single source to a multiple of receivers. The technology ensures that only a single packet stream is required from the source regardless of the number of receivers.

Multicast is distributed in a variety of different technologies. Often a tree-like distribution method is utilized with the source or a multicast core device at the root of the tree. From the multicast core the multicast group/stream is then transmitted throughout the network in the most efficient distribution to avoid any traffic from being sent more than once over any link and to avoid the use of links downstream of which no receivers are present.

Each receiver tunes in to the multicast group/stream by “joining” it, typically using, the Internet Group Management Protocol (IGMP). The adjacent data packet forwarder (typically a router or layer 2 switch) intercepts the IGMP message and establishes the necessary forwarding states internal to the system. If the intercepting device adjacent to the end host is a layer 2 device, the IGMP message is transmitted onward through the layer 2 network until it reaches a router device. Each layer 2 device in the packet path from the host to the router may act on the IGMP message and establish necessary forwarding states internal to each system.

When the message is received at the router, the router device establishes the necessary forwarding states internal to the system required for the distribution of the joined multicast group/stream. If the group is not presently distributed by the router device, it converts the IGMP message into a new multicast protocol message, for example a PIM message, and sends the join further on up through the layer 3 network until the message reaches the multicast core or another router where the requested multicast group/stream is already present. Each router along the path establishes necessary forwarding states internal to the system to deliver the multicast group/stream to the receiver.

Access to MediaControl or access to broadcast media in a multicast network is crucial. Commercial channels and media organizations require financial compensation from customers to provide the media. With the current digtal TV set-top-boxes the system is often based on the precense of a smart card in the set-top-box. This smart card can be manipulated (pirate card) allowing a user to receive all TV-channels without paying. In a data packet network, access to channels can be controlled by the network rather than by a box in the users home. In a multicast network this is typically accomplished by one of the data forwarding devices between the receiving host and the multicast core, but close to the receiving host in the network topology. The IGMP message from the host is matched against a list of permitted or denied multicast groups/streams (the channel package). If the group/stream requested is allowed, the establishment of forwarding states can be provided as described above. If denied, the IGMP message is discarded and no forwarding state is established—the receiving host will not get any multicast traffic and thereby not be able to watch the intended channel.

The typical multimedia boxes for multicast reception available today handle the join-without-result by displaying an error message on the TV screen allowing the user to understand that the requested channel could not be received but does not provide any additional information.

### SUMMARY OF THE INVENTION

The present invention provides, for instance, television viewers or the like, with services and information, although they do not subscribe to a specific multicast group/stream.

To achieve its aims, the present invention sets forth a method in a data packet network controlling access to multicast channels, providing to a host for a user requested denied or alternate groups/streams with services and information. The method comprises the steps of:

establishing a forwarding state for a multicast stream in a data forwarding device;

providing an alternate multicast stream to the user by the data forwarding device and switching an alternate multicast stream to the host where the user request originated from and conveying the services and information to the user.

An embodiment of the present invention comprises equipping a data forwarding device in the network with multicast address translation (MAT) technology;

In one embodiment of the invention the translation technology in the data forwarding device changes the alternate multicast group/stream address into a requested multicast group/stream address before the group/stream is transmitted to a requesting host.

In another embodiment, the data forwarding device constantly monitors multicast streams, and, upon reception of a signal in an original multicast stream, replaces the stream with a predetermined different stream.

In a further embodiment, the alternate multicast stream is an audio/video signal that contains commercial messages specifically targeted at a user demographics, geographical location or premises.

In a still further embodiment, the alternate multicast stream causes the replacement of the main digital broadcast stream channel with an analog channel, when a digital cable TV network user is requested to turn to the analogue channel transmission.

In yet another embodiment, a switch back to an original multicast stream occurs after a specific time or at the reception of a reset signal either provided in an original multicast group/stream, which the data forwarding device continuously monitors, or in the alternate multicast stream.

In yet still a further embodiment, a switch back and forth between original and alternate multicast streams is controlled by a predetermined external multicast stream process through a data protocol or configuration of the data forwarding device.

In another embodiment, the alternate multicast stream is stored locally on the data forwarding device, transmitting said alternate multicast stream to a receiver with the multicast stream address of the original multicast group/stream.

Moreover, the present invention provides a system in a data packet network controlling access to multicast channels, providing to a host for a user requested denied or alternate multicast streams with services and information. Thus, the invention comprises:

a data forwarding device having a forwarding state for an alternate multicast stream, said data forwarding device having a translator for providing the alternate multicast stream to the user by switching the alternate multicast stream to the host where a user request originated from and conveying the services and information to the user.

It is appreciated that the system of the present invention is able to conduct the embodiments of the above method in accordance with that shown and described herein.

### BRIEF DESCRIPTION OF THE DRAWINGS

Henceforth, the present invention is described more in detail by examples and embodiments by reference to the attached drawings, whereby:

FIG. 1 schematically illustrates a network with multicasting in accordance with one embodiment of the present invention; and

FIG. 2 schematically illustrates a network with multicasting in accordance with another embodiment of the present invention.

### DETAILED DESCRIPTION OF PREFERRED EMBODIMENTS

In accordance with an embodiment of the present invention, a data forwarding device (layer 2 switch or router) is provided with Multicast Address Translation (MAT) technology. If the MAT system determines that the multicast group/stream requested is not allowed for this particular user, a translation and forwarding state for the multicast group/stream is established. If required, a new multicast group/stream join message (protocol depending on network configuration, for instance IGMP, PIM (Protocol-Independent Multicast), DVMRP (Distant Vector Multicast Routing Protocol), CBT (Core Based Trees)) requesting an alternate multicast group/stream (as determined by the presence of the alternate multicast group/stream in this system and the systems position in the network topology) is created and sent towards the multicast core of the network.

Which alternate multicast group/stream to join/connect to can be determined by configuration, static or dynamic, through information received in the original multicast group/stream or by information received through another data protocol.

The alternate multicast group/stream can in one embodiment of the present invention contain a video/audio stream that audible/visually informs the user that the requested multicast group/stream could not be joined, which telephone number to call to order the service, information about the requested channel or the like.

The translator mechanism MAT in the data forwarding device, such as for instance an ASR (Access Switching Router), changes the alternate multicast group address into the requested multicast group address before the group/stream is transmitted to the requesting host. To the host, the multicast group/stream received is the same as the one requested, but the actual content of the group/stream (the audio/video signal) is not the signal of the original multicast group/stream.

Through this provision, a user will receive a working audio/video signal that the multimedia box can display on a TV screen. The content of that signal can be adapted to provide necessary information to the user for commercial reasons or otherwise. In another embodiment, the data forwarder device constantly monitors multicast streams and upon the reception of a signal in the original multicast stream replaces that stream with another stream. The alternate stream in this case could be an audio/video signal that contains commercial messages specifically targeted at the user demographics, geographical location or otherwise. A typical Swedish implementation could be to replace the main SVT (Swedish Public Service Television Network) signal with the “Regionalnytt” (regional news) signal. In digital cable-TV networks of today users are requested to turn to an analog transmission in order to look at the regional news show. The request can for instance be provided through a text message on the TV-screen or in other known manners.

With this solution, the regional news show would be available in an alternate multicast group/stream and replace the multicast group/stream of the main SVT signal for the duration of the regional news show. The user is not required to change channel and will be able to receive the local information targeted for the user in the digital network. In this solution for the regional news show, the multicast channel is the same but the information stream is altered to send analogous programs different for different regions in Sweden.

A switch back to the original multicast group/stream can occur after a specific time or at the reception of another pilot/trigging signal either in the original multicast group/stream, which the data forwarding device continues to monitor, or in the alternate multicast group/stream. It is also possible that the switch back and forth between original and alternate multicast groups/streams is controlled by an external process/method to the multicast group/stream, for example, through a data protocol or device configuration.

A still further method includes using date and/or time to determine when to switch back and forth between the original and alternate multicast group/stream.

Yet a still further method includes storing the audio/video signal locally on the data forwarding device, typically in one embodiment of the present invention in MPEG format, and transmit it to the receiver with the multicast group address of the original multicast group/stream. In this embodiment, the alternate multicast group/stream is locally generated by the data forwarding device and not received from a centrally placed source.

Although, the present invention is exemplified through multicasting of TV channels, it is appreciated that its technology likewise can be utilized for any distribution of multicast information without changes to the underlying concept of the invention.

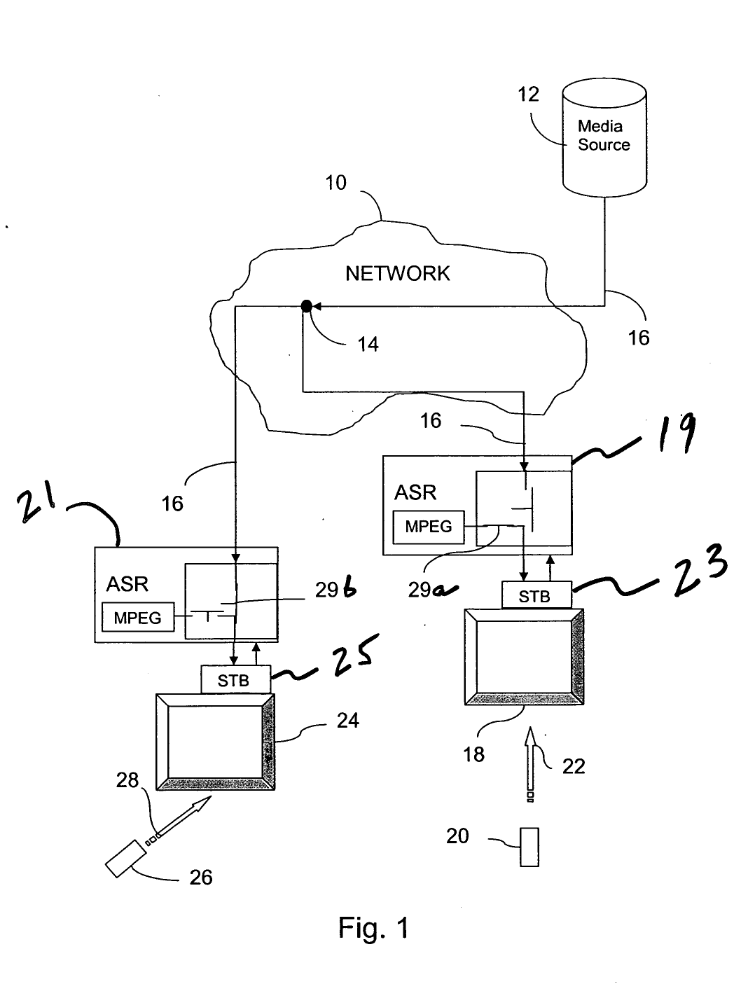

In particular, FIG. 1 schematically illustrates a packet network 10 with multicasting in accordance with one embodiment of the present invention. A media source 12, such as for instance the Swedish operators ComHem®, Viasat®, UPC ® or the like, is broadcasting one or more TV channels, and a node 14 (multicasting core device) for multicasting in the network 10 distributes channels 16 to TV-sets 18, 24 and their users in accordance with a users subscription for specific channels. In the embodiment of FIG. 1, the data forwarding device is an ASR router such as 19 or 21 which determines what users or which TV-sets 18, 24 are connected to a subscription for the one or more channels 16 conveyed.

In the embodiment of FIG. 1, the forwarding device ASR 19 or 21 connects respectively subscribers set-top-boxes (STB) 23 or 25 to channel(s) 16 chosen through remote controls 20, 26 selected by pressing a button on the remote control 20, 26, thus transmitting a channel selection signal 22, 28 to the ASR router 19 or 21. A switching means 29a or 29b in the ASR router 19 or 21 connects the user or TV-set 18 or 24 to a selected channel 16 if the user is a subscriber. The embodiment shown in FIG. 1 depicts that the user or TV-set 24 has a subscription and thus the channel 16 is connected to the TV-set 24 when the switching means 29b is closed. The switching means 29a or 29b can be any known means to switch from one channel to another, or from one channel multicast stream to another stream comprised in the same channel.

In comparison, in FIG. 1 the user or TV-set 18 is denied access to the channel 16 when the switching means 29a is open. In known networks such as 10, a denied user would typically receive a black picture on the screen of the TV-set 18 or at most a message saying access denied. However, in the embodiment of FIG. 1 of the present invention, a video program or the like is stored in the router ASR 19 for instance in the MPEG format, thus the user denied access to the channel 16 is, through the switching means 29a, provided a video or the like on the screen of the TV-set 18 instead of a totally dark or black picture or otherwise colored picture. This video or the like could contain any information, such as an ad or film. In a similar manner, the TV-set 24 would also be provided the video if there was no subscription for channel 16 accorded in the list.

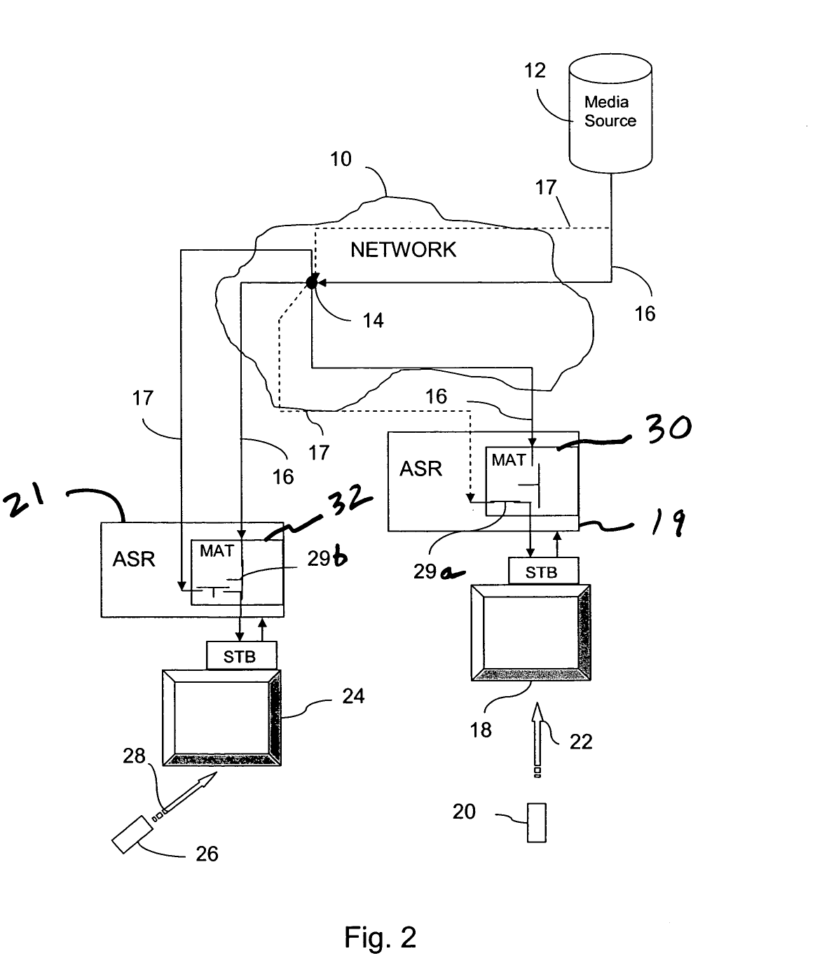

The packet network 10 depicted in FIG. 2 provides an alternative embodiment of the present invention for connecting the user or TV-set 18 or 24 to a chosen subscribed channel(s) 16. However, here there is no video stored in the router ASR 19 or 21. For the convenience of the leader, in FIG. 2 similar elements to that shown in FIG. 1 are provided with similar reference numerals. Instead, the media source 12 multicasts a separate channel 17, indicates by broken lines, with information that is intended to be displayed to users not subscribing to channel 16. In a similar manner as that shown in FIG. 1, the ASR router 19 or 21 functions as a data forwarding device in the network, but in FIG. 2 multicast address translation (MAT) technology means 30 or 32, determines through a MAT list that the TV-set 18 is denied the channel(s) 16 and thus switches with switching means 29a the channel 17 to the TV-set 18. As in FIG. 1, the user or TV-set 24 subscribing to channel 16 is connected to the channel 16 through the switching means 29b but here decided by the list in MAT 32. It is appreciated that the channel 17 could be transmitted from any suitable place in the network 10 in accordance with the present invention.

The present invention has been described through examples and preferred embodiments, but it is only restricted, for a person skilled in the art, by the attached claims.

1. A method in a data packet network controlling access to multicast channels, providing to a host for a user requested multicast streams with services and information, comprising the steps of:
establishing a forwarding state for the multicast stream in a data forwarding device;
providing an alternate multicast stream to the user by the data forwarding device and switching the alternate multicast stream to the host where the user request originated from, and conveying the services and information to the user.

2. A method according to claim 1, wherein the data forwarding device includes with multicast address translation technology.

3. A method according to claim 2, wherein said multicast address translation technology in said data forwarding device changes an alternate multicast stream address into a requested multicast group address before the alternate multicast stream is transmitted to a requesting host.

4. A method according to claims 1, wherein said data forwarding device constantly monitors multicast streams, and upon reception of a signal in an original multicast stream, replaces an original multicast stream with a predetermined different stream.

5. A method according to claims 1, wherein said alternate multicast stream is an audio/video signal that contains commercial messages specifically targeted at a user demographics, geographical location or premises.

6. A method according to claims 1, wherein said alternate multicast stream causes the replacement of a main digital multicast stream channel with an analog channel, when a digital cable TV network user is requested to turn to analog channel transmission.

7. A method according to claims 1, wherein a switch back to an original multicast stream occurs after a specific time or at the reception of a reset signal either provided in an original multicast group/stream, which said data forwarding device continuously monitors, or in said alternate multicast stream.

8. A method according to claims 1, wherein a switch back and forth between original and alternate multicast streams is controlled by a predetermined external multicast stream process through a data protocol or configuration of said data forwarding device.

9. A method according to claims 1, wherein said alternate multicast stream is stored locally on said data forwarding device, transmitting said alternate multicast stream to a receiver.

10. A system in a data packet network controlling access to multicast channels, providing to a host for a user requested multicast streams with services and information, comprising:
a data forward device having a forwarding state for a multicast stream,
said data forwarding device having a translator for providing an alternate multicast stream to said user by switching the alternate multicast stream to the host where a user request originated from and conveying the services and information to the user.

11. A system according to claim 10, wherein said data forwarding device includes multicast address translation technology;

12. A system according to claim 11, wherein said translator changes an alternate multicast group address into said requested multicast group address before the group/stream is transmitted to a requesting host.

13. A system according to claims 10, wherein said data forwarding device constantly monitors multicast streams, and upon reception of a signal in an original multicast stream, replaces an original multicast stream with a predetermined different stream.

14. A system according to claims 10, wherein said alternate multicast stream is an audio/video signal that contains commercial messages specifically targeted at a user demographics, geographical location or premises.

15. A system according to claims 10, wherein said alternate multicast stream causes the replacement of main digital multicast stream channel with an analog channel, when a digital cable TV network user is requested to turn to analog channel transmission.

16. A system according to claims 10, wherein a switch back to an original multicast stream occurs after a specific time or at the reception of a reset signal either provided in an original multicast group/stream, which said data forwarding device continuously monitors, or in said alternate multicast stream.

17. A system according to claims 10, wherein a switch back and forth between original and alternate multicast streams is controlled by a predetermined external multicast stream process through a data protocol or configuration of said data forwarding device.

18. A system according to claims 10, wherein said alternate multicast stream is stored locally on said data forwarding device, transmitting said alternate multicast stream to a receiver.
